(19) United States
(12) Patent Application Publication
(10) Pub. No.: US 2023/0230471 A1
(43) Pub. Date: Jul. 20, 2023

(54) COOPERATIVE TRAFFIC CONGESTION DETECTION FOR CONNECTED VEHICULAR PLATFORM

(71) Applicant: TOYOTA MOTOR ENGINEERING & MANUFACTURING NORTH AMERICA, INC., Plano, TX (US)

(72) Inventors: MEHMET ALI GUNEY, Plano, TX (US); Rui Guo, Plano, TX (US); Prashant Tiwari, Plano, TX (US)

(21) Appl. No.: 17/576,082

(22) Filed: Jan. 14, 2022

(51) Int. Cl. G08G 1/01; G08G 1/0965; B60W 60/00

(52) U.S. Cl. CPC G08G 1/012; G08G 1/0141; G08G 1/0965; B60W 60/001; G06V 20/58

(57) ABSTRACT

Systems and methods are provided to implement cooperative traffic congestion detection, and enhance the accuracy of detection of traffic congestion for enhanced routing and maneuvering vehicles along a travel route. A vehicle is configured to receive vehicle data from an ad-hoc network of a plurality of vehicles that are communicatively connected (and proximately located). A subset of the plurality of vehicles can be sensor-rich vehicles that are equipped with ranging sensors (e.g., cameras, LIDAR, radar, ultrasonic sensors), which enables real-time detection of the multiple traffic parameters, such as the presence of other vehicles, vehicle speed, vehicle movement, traffic, and the like, within the vicinity along the route. The vehicle employs cooperative traffic congestion detection, and fuses data from the plurality of vehicles, including sensor-rich vehicles and legacy vehicles, and applies a learning-based algorithm, such as a machine-learning (ML) algorithm, to generate a real-time and more accurate estimate of traffic congestion.

### TECHNICAL FIELD

The present disclosure relates generally to vehicle communication and vehicle navigation and/or computer-controlled driving technology. In particular, data from a plurality of vehicles having communication capabilities can be used in determining an estimate of traffic congestion for vehicles.

### DESCRIPTION OF RELATED ART

Traffic detection generally involves devices or systems that have the capability to detect the presence or movement of vehicles. These device can then relay the information which is analyzed, typically by centralized servers or computational nodes, to aide in detecting real-time traffic or observing traffic patterns over time. Various types of existing traffic detection mechanisms can include: in-roadway sensors that sit on and/or under the surface (e.g., on pavement, on the surface of the road, etc.) to detect traffic-flow by detecting pressure changes that occur on the road surface; over roadway sensors (e.g., ultrasonic and passive infrared sensors) that sit above the road, and are often installed on the roadway or alongside the road, closest to vehicle movement on roads. Some common types of over roadway sensors include navigation systems, which typically include application platforms, to collect real-time information (e.g., vehicle speed, traffic conditions, and road structures) from sensors implemented on and/or near the vehicle to remotely located centralized systems to detect the presence of traffic and recognize traffic patterns.

In many cases, traffic detection serves as the basis for handling various other operational tasks of the vehicles. For example, if a vehicle is approaching a route where traffic congestion is detected, the vehicle may be alerted to slow down or rerouted. Overall, traffic detection and management of roadways is important, as ever-increasing rates of traffic issues across roads today is becoming a challenge. Using mechanisms such as traffic detection systems can be crucial in solving such problems, and can allow for drivers and/or vehicles to make the right adjustments to make congestion easy to manage and reduce injuries.

### BRIEF SUMMARY OF THE DISCLOSURE

In accordance with embodiments of the disclosed technology, cooperative traffic congestion detection methods and systems are implemented that enhance the accuracy of detecting traffic congestion for enhanced routing and maneuvering vehicles along a travel route. In an embodiment, a vehicle is configured to receive data from an ad-hoc network of a plurality of vehicles that are communicatively connected (and proximately located). A subset of the plurality of vehicles can be sensor-rich vehicles that are equipped with ranging sensors (e.g., cameras, LIDAR, radar, ultrasonic sensors), which enables real-time detection of the multiple traffic parameters, such as the presence of other vehicles, vehicle speed, and vehicle movement, traffic, and the like, within the vicinity along the route. Another subset of the plurality of vehicles can be legacy vehicles that have limited sensor and/or communication capabilities. The vehicle employing cooperative traffic congestion detection can then fuse the data received from both subsets of the plurality of vehicles, including sensor-rich vehicles and legacy vehicles, and applies a learning-based algorithm, such as a machine-learning (ML) algorithm, to generate a real-time estimate of traffic congestion.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is an example road environment including a vehicle utilizing cooperative traffic congestion detection to navigate during a computer-controlled operational mode, for example, in accordance with an embodiment of the technology disclosed herein.

FIG. 2 depicts a schematic representation of a data interface of a cooperative traffic congestion detection system on a vehicle, in accordance with an embodiment of the technology disclosed herein.

FIG. 3 depicts another example road environment including a vehicle utilizing cooperative traffic congestion detection to navigate during a computer-controlled operational mode, in accordance with one embodiment of the systems and methods described herein.

FIG. 4 is a schematic representation of an example vehicle with which embodiments of the cooperative traffic congestion detection system disclosed herein may be implemented.

FIG. 5 illustrates an example communication architecture of the vehicle shown in FIG. 1, in accordance with one embodiment of the systems and methods described herein.

FIG. 6 is an example computing component that may be used to implement various features of embodiments described in the present disclosure.

The figures are not exhaustive and do not limit the present disclosure to the precise form disclosed.

### DETAILED DESCRIPTION

Some vehicles include computer-controlled operational modes, such as vehicles having adaptive cruise control mode and automated vehicles, in which a computing system is used to navigate and/or maneuver the vehicle along a travel route. During adaptive cruise control operation, for example, the driving speed of the vehicle can be limited by various factors, such as traffic congestion (e.g., preceding vehicles travelling at slower speeds, preceding vehicles stopped). In another example, many existing vehicle navigation systems alert a driver of the presence of traffic along an intended route, in order to provide traffic related information that may be pertinent to driving, such as alternate routes and time delay estimations. Thus, the mechanisms employed by vehicles to detect traffic congestion should have relatively high accuracy, especially when utilized with computer-controlled operational modes (e.g., detecting traffic directly impacts operation of the vehicle).

However, some currently employed mechanisms for traffic detection, such as navigation systems, rely on drivers sharing real-time information (e.g., vehicle speed, traffic conditions, and road structures) to remotely located cloud computing systems and/or edge computing systems. Thus, the overall performance and accuracy of these mechanisms for detecting traffic are dependent upon the reliability and strength of communication between the vehicle and the remote cloud and/or edge computers. For example, in instances where a vehicle's communication to the cloud is weak (or otherwise interrupted) these conventional mechanisms may be incapable of properly collecting the information needed for analysis, and in turn would not be able to provide the driver with accurate traffic detection and other related information (e.g., the most optimal route to their destination) used to efficiently and safely navigate and/or maneuver the vehicle on the road. For these reasons, it can be helpful for a vehicle computing system to employ the cooperative traffic congestion detection techniques, as disclosed herein, which involve federated learning by leveraging an ad-hoc network of multiple communicatively connected vehicles as communication points (as opposed to communication with remote cloud computing and/or edge computing systems).

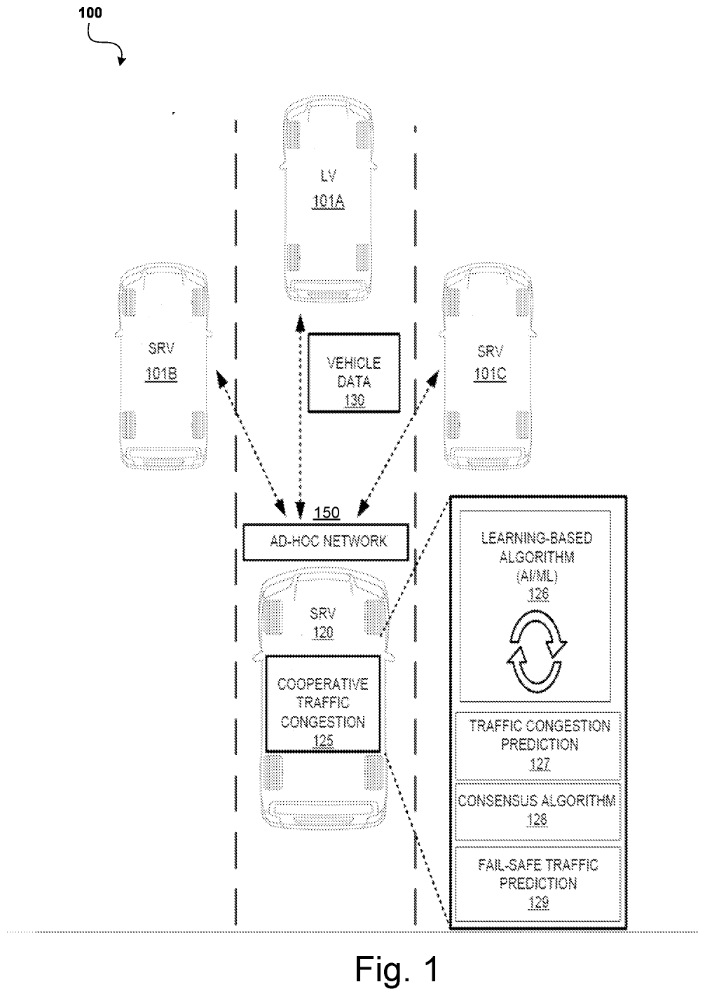

Referring now to FIG. 1, an example of a road environment is depicted, which includes a plurality of vehicles 101a-101c traveling on a roadway with a vehicle 120 that is configured to implement cooperative traffic congestion detection, as disclosed herein. FIG. 1 illustrates that while vehicle 120 is operational, for instance being driven in a computer-controlled operational mode such as adaptive cruise control, the vehicle 120 may be traveling at a certain speed in a lane on the roadway. While vehicle 120 is being driven along the road, FIG. 1 shows that it is also surrounded by the plurality of vehicles 101a-101c. This is a common road environment in several different real life scenarios, for instance driving during rush hours, driving in densely populated areas (e.g., metropolitan areas), and the like. Further, as seen in FIG. 1, vehicle 120 is traveling directly behind vehicle 101a in the same lane.

For purposes of illustration, vehicle 101a, which is preceding the other vehicles 101b, 101c, and 120 on the roadway, is approaching upcoming traffic congestion where other vehicles (not shown) ahead on the roadway are traveling at a significantly reduced speed (or completely stopped). As a result, vehicle 101a may be traveling at a slower rate of speed than vehicle 120 and the other vehicles 101b, 101c that are riding in the other lanes of the roadway. In the example, vehicles 101b, 101c may initially be moving faster than vehicle 101a, but eventually need to adjust their speed to slow down due to upcoming traffic, and thus will end up traveling at the same speed as the slower vehicle 101a that is in front of vehicle 120. Accordingly, in this scenario, vehicle 120 may be described as being in a lane of a roadway that is experiencing traffic congestion. By employing the cooperative traffic congestion controller 125, vehicle 120 has the capability to leverage an ad-hoc network 150 between the other communication-capable vehicles 101a-101c in its vicinity on the road, in order to collect related data.

Vehicle 120 can then utilize this data from the neighboring vehicles 101a-101c in order to detect the presence of traffic, and ultimately make a prediction about the traffic congestion level. In some embodiments, the vehicle 120 can further utilize a fail-safe traffic prediction 129 that is ultimately generated by the cooperative traffic congestion detection controller 125 as a trigger for other functions. The cooperative traffic congestion detection controller 125 can generate notifications, warnings, alerts, and other visual, audio, and tactile outputs that enable drivers to make safer actions in operating the vehicle 120, and provide additional reaction time for unexpected changes on the road. Furthermore, the cooperative traffic congestion detection controller 125 can generate notifications, warnings, alerts, for operators of other vehicles that may be traveling on the road behind vehicle 120, and thus are approaching the section of the road where vehicles 120 is currently traveling. For example, drivers of the upcoming vehicles are informed about any detected traffic congestion along the road, and other changes in the traffic condition such that those drivers have additional time to revise their actions or routes accordingly.

In other words, as the cooperative traffic congestion detection controller 125 detects traffic congestion, the vehicle 120 is configured to use this data from the controller 125 to further notify the driver and/or effectuate automated (or semi-automated) maneuvers of the vehicle 120 such that collisions, slowdowns, and road closures are avoided. For example, in the case where the cooperative traffic congestion detection controller 125 detects that there is upcoming heavy traffic congestion along the roadway it is currently traveling, other components and/or systems of the vehicle 120 may generate alerts for the driver (e.g., indicating traffic), automated maneuvers (e.g., increasing speed, decreasing speed, changing directions, lane change, etc.), and the like.

As will be described in detail herein, the cooperative traffic congestion detection techniques leverage federated learning, which provides enhanced accuracy over traffic detection that is fully dependent upon an individual observation of a single vehicle. For instance, vehicle 120 merely activating its own sensors, such as vehicle cameras, in an attempt to detect the traffic scene may lead to false detection of traffic congestion. In contrast, the disclosed cooperative traffic congestion detection controller 125 functions cooperatively with other vehicles, namely vehicles 101a-101c in the example of FIG. 1 through the ad-hoc network 150, in order to coordinate analysis and/or share information. As an example, the vehicles 101a-101c can have sensors that detect portions of the roadway that are currently undetectable to vehicle 120, which is driving behind those vehicles 101a-101c and thus is on another section of the road.

FIG. 1 also depicts that a subset of the plurality of vehicles on the roadway are sensor-rich vehicles (SRVs) that are equipped with advanced vehicles sensors, described herein as ranging sensors (e.g., cameras, LI DAR, radar, ultrasonic sensors) and, in some cases, advanced computational resources. Particularly in the example of FIG. 1, vehicles 101b, 101c, and 120 are implemented as SRVs. Accordingly, as SRVs, vehicles 101b, 101c, and 120 are enabled to utilize these advances sensors to sense various conditions on the roadway, and obtain data that is pertinent to traffic detection, such as, but not limited to: vehicle identifiers; the presence of other vehicles; vehicle position; vehicle speed; vehicle movement; vehicle motion direction; road data; lane data; vehicle acceleration; other static and dynamic objects; image data; planned route data; generated HD local map; processed perception data; and the like. Another subset of the plurality of vehicles in the road environment can be legacy vehicles (LVs) that have limited sensor and/or communication capabilities in comparison to the SRVs. FIG. 1 depicts vehicle 101a as a LV. As described herein, LVs, such as vehicle 101a, have sensors that are capable of sensing and communicating more basic types of vehicle data, such as vehicle identifiers, vehicle location, vehicle speed, vehicle acceleration, and the like. For instance, LVs can include Global Positioning System (GPS) sensors, which can provide the basic location, velocity, and acceleration of the vehicle.

Additionally, FIG. 1 shows that that vehicle data 130 (generated by the SRVs 101b, 101c, and LV 101a) can be communicated to the vehicle 120, via the ad-hoc network 150, from the other communicatively connected vehicles 101a-101c within the vicinity on the roadway. Vehicle data 130 can include data collected by the vehicle sensors of SRVs and LVs, other related data, and additional traffic congestion predictions (i.e., from other vehicles implementing cooperative traffic congestion detection) that are transmitted from the vehicles 101a-101c. The vehicles 101a-101c and 120 can have vehicle-to-vehicle (V2V) communication capabilities. Thus, vehicles 101-101c and 120 utilize V2V communication's ability to form the ad-hoc network 150 (as the vehicles are within range for V2V-based wireless communication), and wirelessly exchange information, such as speed and position of surrounding vehicles. That is, in the road environment 100 of FIG. 1, V2V enables all of the vehicles 101a-101c, and 120 to be able to communicate with each other. Vehicle 120 can receive and analyze the received vehicle data 130, and employ other vehicle components and/or systems, such as the cooperative traffic congestion controller 125, to help perform automated actions that avoid crashes, eases traffic congestion, and overall improves the road environment 100. The federated learning features are a key aspect of the cooperative traffic congestion detection techniques, as disclosed herein, and helps vehicle 120 achieve a more accurate (potentially fault-free) traffic congestion detection as compared to conventional traffic congestion detection mechanisms.

In some embodiments, the SRVs, namely vehicles 101b, 101c, and 120 also include vehicle-to-infrastructure (V2I) and/or vehicle-to-everything (V2X) capabilities. Accordingly, vehicles 101b, 101c, and 120, which are the SRVs in the example, can employ V2I and/or V2X communication to wireless exchange additional data between the vehicles and road infrastructure. Thus, in some cases, the ad-hoc network 150 can include infrastructure components such as lane markings, road signs, and traffic lights which can wirelessly provide information to the vehicle, and vice versa. Consequently, the vehicle data 130 can include additional data obtain from these infrastructure components in V2I and/or V2X communication, allowing the cooperative traffic congestion detection controller 125 to have a vast amounts real-time, information rich, data that is related to road safety, energy savings, and traffic efficiency on the roads in order to further enhance the accuracy and the overall performance of its traffic congestion detection functions. In some embodiments, the vehicle 120 is further configured to employ the bidirectional communication of V2I and/or V2X to also provide the roadside units, cloud/edge servers, and traffic monitoring centers, with notifications of traffic congestion that it has detected, when required and/or requested from the infrastructure.

Particularly, vehicle 120 is shown to include a cooperative traffic congestion detection controller 125. The cooperative traffic congestion detection controller 125 can be implemented as a vehicle controller, computing hardware, software, firmware, or a combination thereof, which is programmed to detect and/or predict the presence of traffic congestion in accordance with the disclosed techniques. The cooperative traffic congestion detection controller 125 may be a standalone controller in some embodiments. Alternatively, the cooperative traffic congestion detection controller 125 may be implemented by configuring a main vehicle onboard processor or CPU. Further, FIG. 1 illustrates that the cooperative traffic congestion detection controller 125 can include several other components and data, including, but not limited to: learning-based module 126; traffic congestion prediction 127; consensus module 128; and fail-safe traffic prediction 129. As previously described, vehicle 120 can obtain vehicle data 130 from the other communicatively connected vehicles 101a-101c on the road, via the ad-hoc network 150. This received vehicle data 130, as obtained by the SRVs and the LVs in the network, can be cooperatively fused and serve as input to the cooperative traffic congestion detection controller 125.

Specifically, the learning-based module 126 uses this data, and applies learning-based algorithms to predict the changes in the traffic in a manner that detects whether there is a presence of traffic congestion at some portion of the roadway. The learning-based module 126 can be implemented in accordance with one of several known learning-based techniques, such as machine-learning (ML), artificial intelligence (AI), neural network, deep learning, and the like. In the example of FIG. 1, the learning-based module 126 is illustrated as being implemented to use ML/AI.

Furthermore, FIG. 1 illustrates that the output of the learning-based module 126 is the traffic congestion prediction 127. Stated another way, the vehicle's 120 individual analysis of the data (using its cooperative traffic congestion detection controller 125) will generate the vehicle's own traffic congestion prediction 127. That is, the traffic congestion prediction 127 may serve as an preliminary (or initial) prediction, prior to the consensus functions being performed by the cooperative traffic congestion detection controller 125. In the example, the traffic congestion prediction 127 of vehicle 120 may indicate, independently of traffic predictions from other vehicles, that it is detecting traffic in its lane of the roadway (e.g., due to the slowdown of vehicle 101a).

According to the embodiments, consensus (also referred to herein as federated learning) aspects are employed to increase the accuracy, confidence, and eliminate false detections of the traffic congestion predications made by the system. In addition to sensor data, the vehicle data 130 can include other traffic predictions that have been generated by other vehicles that are in the vicinity (e.g., within V2V communication range) on the roadway that are also implementing the cooperative traffic congestion detection capabilities. Thus, as an example, if vehicles 101b, 101c are also configured with cooperative traffic congestion detection controllers, these proximately located (e.g., on the ad-hoc network 150) vehicles 101b, 101c can share their individually determined traffic congestion predictions with vehicle 120. Thereafter, the consensus module 128 is executed to enable the communicating vehicles to reach an agreement on the traffic state with higher confidence. That is, by receiving several different traffic predictions that have been independently calculated by different vehicles, such as 101b, 101c, and 120 in FIG. 1, these predictions can be analyzed to determine if the observed predictions converge (indicating that the vehicles have reached an agreed consensus) or diverge (indicating that the vehicles have not reached an agreed consensus and/or the vehicles disagree).

For example, vehicle 120 detects the traffic in its lane (due to vehicle 101a traveling slowly), and the vehicles 101b, 101c detect the upcoming traffic congestion that is ahead on the roadway (that vehicle 120 may not be able to readily detect). As a result of the consensus module 128 determining that the vehicle's 120 individual traffic predictions indeed converge to an agreed consensus with the traffic predictions of vehicle 101b, 101c, the individual predictions are validated, and in-turn a fail-safe traffic prediction 129 is generated. Referring back the example, vehicles 120, 101b, and 101c reaching a consensus on traffic congestion being present on their segment of the roadway (e.g., each individual traffic prediction indicates presence of traffic congestion), would result in a fail-safe prediction 129 that traffic congestion has been detected. With a consensus-based traffic prediction, the disclosed techniques can predict the status of the traffic in a manner that mitigates misrepresentations and/or mis-predictions that have a higher likelihood of occurring in a single vehicle observation approach. After consensus validation is performed by the consensus module 128, the fail-safe traffic prediction 129 data can be shared with all vehicles within the communication range of vehicle 120.

Consequently, this accurate traffic congestion detection information generated by the cooperative traffic congestion detection controller 125 will enable drivers and/or the computer-controlled operation to take safe and efficient driving actions in the presence of heavy traffic. Thus, the disclosed cooperative traffic congestion detection system and method achieve accurate and efficient traffic detection, without relying on any centralized server or computational node. As alluded to above, a vehicle equipped with the cooperative traffic congestion detection controller 125 of FIG. 1, can leverage communication with other vehicles to perform traffic detection computation using its onboard processor, for example.

FIG. 1 illustrates an example of the cooperative traffic congestion detection system that can realize improved safety by detecting traffic congestions and enabling a vehicle with the capability to warn upcoming vehicles (within the communication range), via their drivers and/or the computer-controlled driving system, in the event of detecting traffic congestion. Thus, the cooperative traffic congestion detection system can provide additional reaction time to the drivers (e.g., to reconsider routes and/or driving maneuvers). By leveraging connectivity between vehicles, learning-based detection algorithm, and multiple traffic-related parameters, the flexibility of detection of various levels of traffic congestion is increased without requiring manual parameter tuning or approximation/fitting function. Furthermore, leveraging vehicle connectivity, enables vehicles to perform consensus analysis (within an ad-hoc network), where vehicles can broadcast their observed traffic status for upstream vehicles without depending on roadside units. Moreover, the cooperative traffic congestion detection system utilizes sensor-rich vehicles as a computation and/or sensor node, thereby eliminating the need for computation edge and/or cloud and a fixed traffic monitoring center.

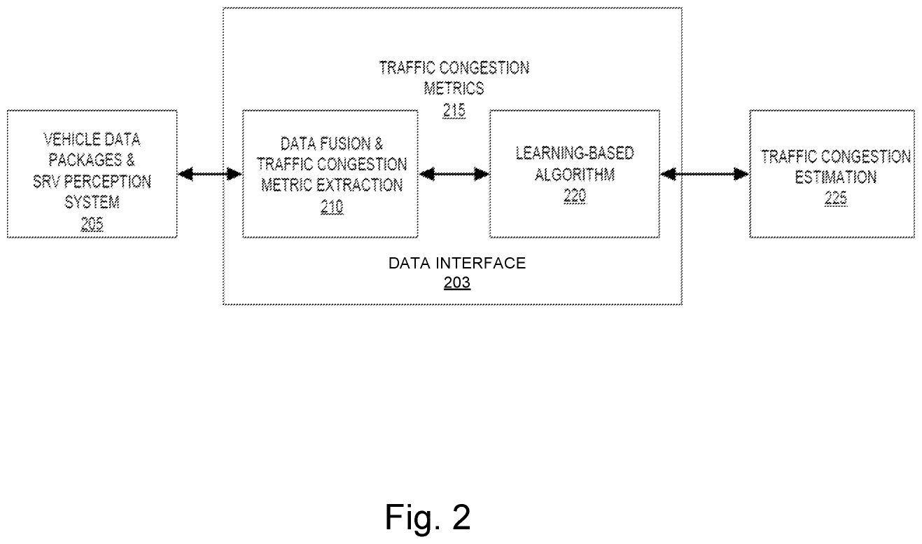

Referring now to FIG. 2, a block diagram of an example data interface 203 of a cooperative traffic congestion detection system is depicted. According to an embodiment, the data interface 203 is implemented as a component of the cooperative traffic congestion detection controller (shown in FIG. 1) of a vehicle, which is configured for bidirectional communication allowing the controller, ad-hoc network, other vehicles, and other components/systems on the vehicle to communicate with each other by transmitting data and/or other information between devices. Furthermore, FIG. 2 shows examples of interactions of the data interface 203 with various types of data that may be involved in the cooperative traffic congestion detection process. Particularly, FIG. 2 illustrates the data interface 203 receiving vehicle data packages SRV perception system data 205, transferring traffic congestion metrics 215, and outputting a traffic congestion estimation 225.

As previously described, the disclosed system utilizes a plurality of vehicles, leveraging the SRVs/LVs on-vehicle sensor and computing resources, as a network of distributed sensors and computing nodes. By employing vehicle based communication technology, such as V2V, the system (e.g., implemented as a controller on a vehicle) includes an interface with the communicatively coupled vehicles (SRVs and LVs) that are within the communication range in the traffic scene (or roadway). For example, by employing V2V, each vehicle in an ad-hoc network is identified with a corresponding and unique vehicle identifier (id). This vehicle communication allows for one or more vehicles (implementing the cooperative traffic congestion detection system) to collect vehicle data from other LVs and SRVs within the communication proximity.

In FIG. 2, this is illustrated as the vehicle data packages (e.g., vehicle data communicated from other vehicles) and SRV perception system data (e.g., data from vehicle's own on-vehicle sensors) 205 being received by the data interface 230. In some cases, the vehicle combines the vehicle data packages received from neighboring vehicles (e.g., on the ad-hoc network) with its perception data generated by sensors to generate data 205. Thus, the data 205 can be ultimately obtained by the cooperative traffic congestion detection controller (shown in FIG. 1), vis-à-vis the data interface 203. In a data fusion and traffic congestion metric extraction module 210, the vehicle can fuse and extract certain parameters from the obtained data 205, and derives various traffic congestion metrics 215. For example, data related to local traffic congestion metrics 215 can include: traffic flow; traffic density; neighbor or detected vehicles' velocity; acceleration/deceleration; average acceleration/deceleration; relative velocity; average velocity; and relative distance of vehicles in the traffic scene. FIG. 2 shows that the traffic congestion-related metrics 210 generated from the are transferred, by the data interface 203, to the learning-based algorithm 220. The traffic congestion metrics 215 are then utilized by the learning-based module 220 to estimate and/or detect traffic congestion. Rather than using a user-defined function of vehicle position to detect traffic congestion, the disclosed cooperative traffic congestion detection techniques utilize the learning-based module 220, which provides the self-tuning and increased flexibility advantages associated with ML/AI.

Accordingly, FIG. 2 depicts a data result from the learning-based module 220 as traffic congestion estimation 225. Finally, the vehicle can share its traffic congestion estimation 225 (which is generated independent of traffic estimations from other vehicles) with the other vehicles within the ad-hoc network for further analysis in the consensus aspects of the cooperative traffic congestion detection techniques. FIG. 2 illustrates the traffic congestion estimation 225 being output by the data interface 203, in order to be communicated to other communicatively connected vehicles within range (e.g., via the ad-hoc network). By communicating the traffic congestion estimation 225 generated by one vehicle to be analyzed by several different vehicles, the traffic estimation can be validated against other traffic congestion predictions generated by the other vehicles' observations. The cooperative traffic congestion detection system, as disclosed herein, realizes the benefits from federated learning and coordination of multiple vehicles in order to enhance the accuracy and reliability of decisions on traffic congestion detection.

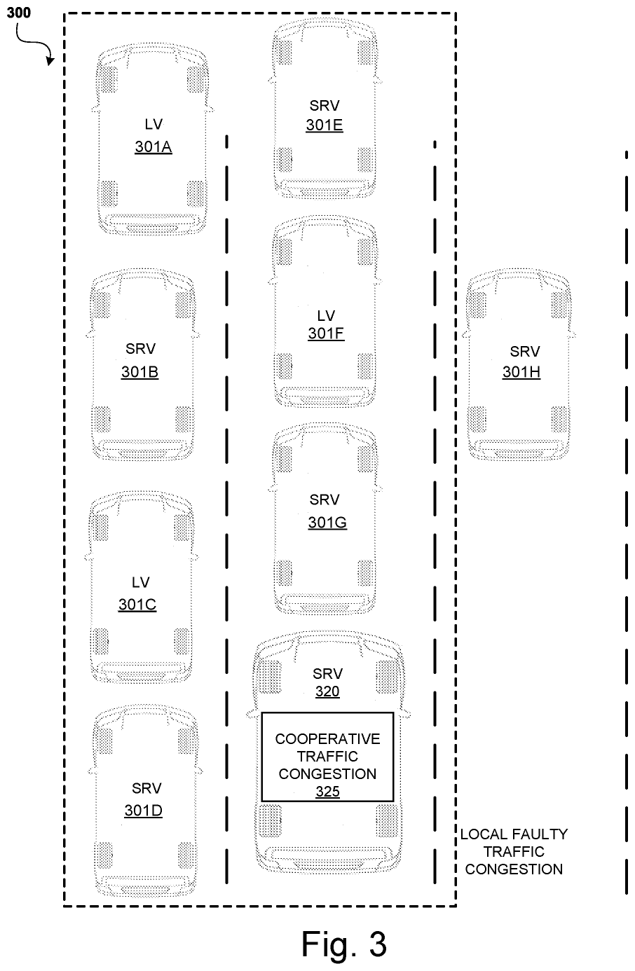

SRV may detect a slow and congested area and warn the upcoming vehicles; however, this would be misleading because this is a local congestion observation and does not represent the whole traffic scene. Another example is shown in FIG. 3, where there is an HV lane on the freeway/highway or a single lane that is not affected by traffic congestion. Multiple SRVs can detect a slow-down in the traffic, but this change may not impact the vehicles in the HV lane (free-flow motion), which makes it harder for them to detect the congestion. Therefore, they may ignore warning the upcoming vehicles that are not in the HV lane, which may result in undesired consequences.

FIG. 3 depicts another example road environment including a vehicle 320 utilizing the disclosed cooperative traffic congestion detection techniques. Particularly in FIG. 1, the vehicle 320 includes a cooperative traffic congestion detection controller 325. One or more of the other vehicles 301a-301h depicted in FIG. 3 can also include the cooperative traffic congestion detection controller 325, also enabling these vehicles 301a-301h to perform the cooperative traffic congestion detection functions disclosed herein. The function and structure of the of the cooperative traffic congestion detection controller 325 is substantially similar to the controller described in reference to FIG. 1. Accordingly, for purposes of brevity, details regarding the cooperative traffic congestion detection controller 325 are not described again in reference to FIG. 3. In the example road environment of FIG. 3, the vehicle 320 is closely surrounded by a plurality of vehicles 301a-301g in neighboring lanes. These lanes of the road can be considered to have local congestion. For example, vehicle 320 is shown behind 301g which may traveling very slowly due to the congestion involving the traffic with the other vehicles 301a-301f also traveling on the road. In this scenario, the vehicles 301a-301g, which are also in a congested section of the roadway, may detect this slow and congested area and warn the upcoming vehicles, such as vehicle 320, in accordance with the disclosed cooperative traffic congestion detection techniques.

However, FIG. 3 also illustrates that a vehicle 301h is traveling in a lane of the roadway where there is no traffic congestion. As seen, vehicle 301h is a lane with no other vehicles, and therefore may be able to travel at a faster rate of speed that the other vehicles 301a-301g, and 320 that are in the congested area of the road. This road environment of FIG. 3 may be common in the real-word, as high occupancy vehicle (HOV) lanes are frequently designated on freeway/highway that are typically not affected by traffic congestion as the open lanes. In this scenario, as vehicle 301h is traveling freely in its lane, and not in the area of the road that is experiencing traffic, it may be difficult for vehicle 301h to detect that there is indeed congestion in the other lanes of the road along the route. In some conventional traffic detection mechanisms, for example relying solely on the on-vehicle cameras, vehicle 301h may generate a false negative suggesting that there is no traffic on the road, based on its independent observation in the HOV lane.

Inaccurate and/or faulty traffic detections may result in undesired consequences, such as the vehicle failing to maneuver safely and/or efficiently along the route, failing to warning other upcoming vehicles (e.g., not in HOV lane) of traffic congestion, and the like. In contrast, the consensus aspects of the disclosed techniques can avoid such false detections (of traffic congestion) that may have a higher likelihood in traffic detection mechanisms that are reliant on an individual observation of a vehicle in the traffic scene. In accordance with cooperative traffic congestion detection techniques, the SRVs/LVs 301a-301h and vehicle 320 are able to form an ad-hoc network, and communicate their individual traffic congestion predictions to ultimately coordinate for a consensus and ensure a fault-free traffic congestion detection. Referring particularly to the example of FIG. 3, vehicle 320 may receive an indication that there is no traffic congestion from vehicle 301h, which is traveling in a lane of the road that is not experience traffic. However, vehicle 320 would also receive other traffic prediction, as observed by the other vehicles 301a-301g that are traveling in section of the road that is congested. In other words, the vehicles 301a-301h, and 320 performing a consensus enables federated learning where the vehicles 301a-301h, and 320 collaboratively learn and share prediction models.

Thus, as vehicle 320 receives the other traffic congestion predictions from the vehicles 301a-301g, the analysis of the cooperative traffic congestion detection controller 325 would be able to determine that the traffic prediction from vehicle 301h (traveling freely in the lane with no traffic congestion) diverges from the other traffic congestion predictions from vehicles that are able to observe the heavy traffic. As illustrated by the road environment example in FIG. 3, utilizing the cooperative traffic congestion detection system, as disclosed, improves accuracy of traffic detection by leveraging vehicle connectivity, consensus, and the availability of vehicles with advanced sensors.

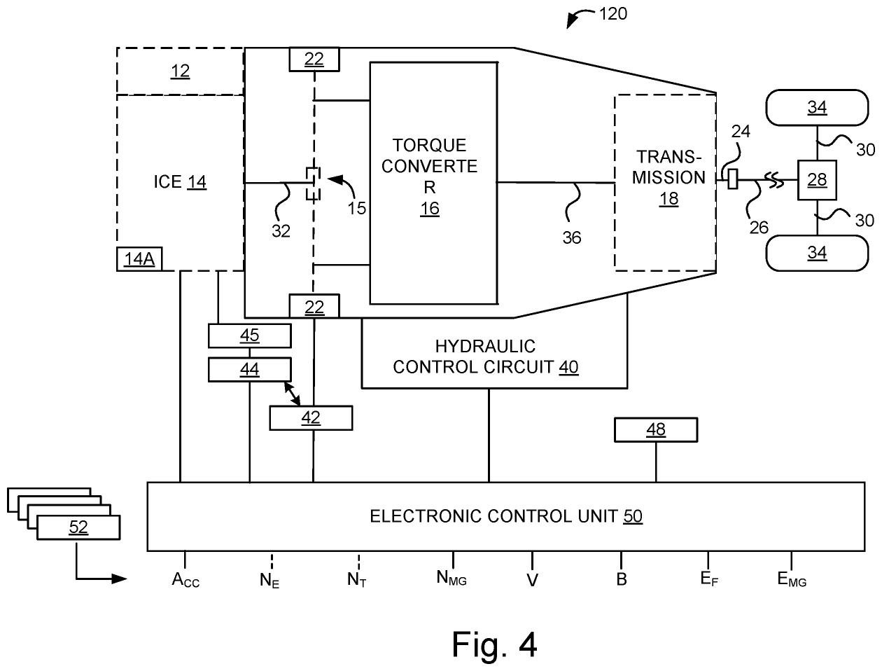

FIG. 4 illustrates a drive system of a vehicle 120 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

Vehicle 120 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be a hybrid electric vehicle (HEV) travel mode that uses engine 14 and the motor(s) 22 as the sources of motive power. In the engine-only and HEV travel modes, vehicle 120 relies on the motive force generated at least by internal combustion engine 14, and a clutch 15 may be included to engage engine 14. In the EV travel mode, vehicle 2 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 120 and is powered electrically via a battery 44. Battery 44 may be implemented as one or more batteries or other power storage devices including, for example, lead-acid batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 120 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS, ESC, or regenerative braking system), battery management systems, and so on. These various control units can be implemented using two or more separate electronic control units or using a single electronic control unit.

In the example illustrated in FIG. 4, electronic control unit 50 receives information from a plurality of sensors included in vehicle 120. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, vehicle 120 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+MG 12) efficiency, acceleration, ACC, etc.

Additionally, the one or more sensors 52 can be configured to detect, and/or sense position and orientation changes of the vehicle 120, such as, for example, based on inertial acceleration. In one or more arrangements, the electronic control unit 50 can obtain signals from vehicle sensor(s) including accelerometers, one or more gyroscopes, an inertial measurement unit (IMU), a dead-reckoning system, a global navigation satellite system (GNSS), a global positioning system (GPS), a navigation system, and/or other suitable sensors. In one or more arrangements, the electronic control unit 50 receives signals from a speedometer to determine a current speed of the vehicle 120.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output. Additionally, as alluded to above, the one or more sensors 52 can be configured to detect, and/or sense in real-time. As used herein, the term “real-time” means a level of processing responsiveness that a user or system senses as sufficiently immediate for a particular process or determination to be made, or that enables the processor to keep up with some external process.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. In some embodiments, cameras can be high dynamic range (HDR) cameras or infrared (IR) cameras. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information. Accordingly, the one or more sensors 52 can be configured to acquire, and/or sense driving environment data. For example, environment sensors can be configured to detect, quantify and/or sense objects in at least a portion of the external environment of the vehicle 120 and/or information/data about such objects. Such objects can be stationary objects and/or dynamic objects. Further, the sensors can be configured to detect, measure, quantify and/or sense other things in the external environment of the vehicle 120, such as, for example, lane markers, signs, traffic lights, traffic signs, lane lines, crosswalks, curbs proximate the vehicle 120, off-road objects, etc.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. In some embodiments, cameras can be high dynamic range (HDR) cameras or infrared (IR) cameras. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information. Accordingly, the one or more sensors 52 can be configured to acquire, and/or sense driving environment data. For example, environment sensors can be configured to detect, quantify and/or sense objects in at least a portion of the external environment of the vehicle 120 and/or information/data about such objects. Such objects can be stationary objects and/or dynamic objects. Further, the sensors can be configured to detect, measure, quantify and/or sense other things in the external environment of the vehicle 120, such as, for example, lane markers, signs, traffic lights, traffic signs, lane lines, crosswalks, curbs proximate the vehicle 120, off-road objects, etc.

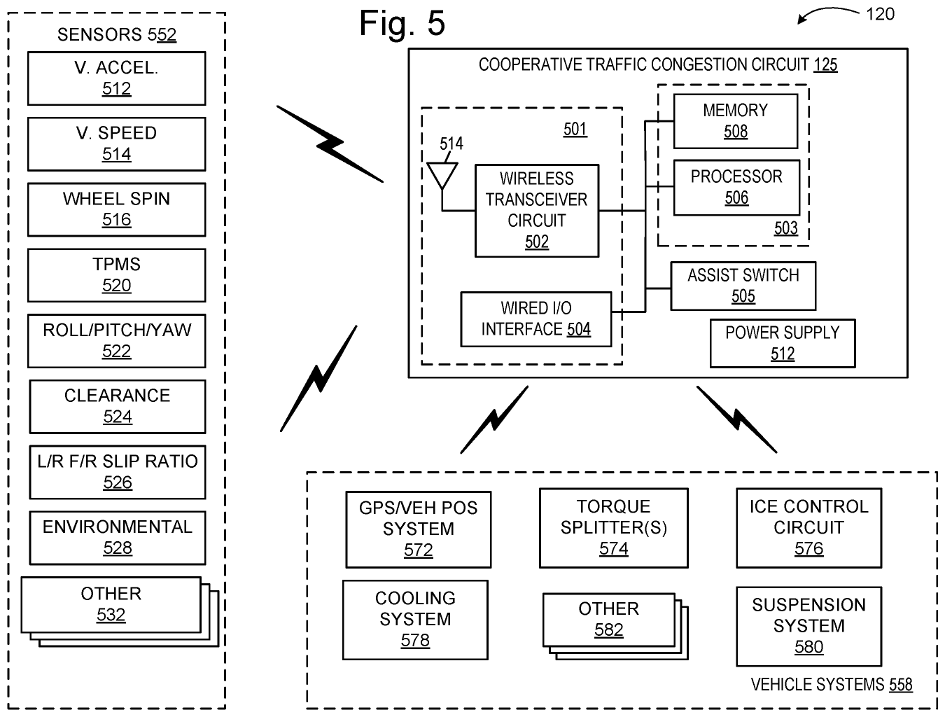

Although the example of FIG. 5 is illustrated using processor and memory circuitry, as described below with reference to circuits disclosed herein, cooperative traffic congestion detection controller 125 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the cooperative traffic congestion detection controller 125.

Communication circuit 201 either or both a wireless transceiver circuit 202 with an associated antenna 214 and a wired I/O interface 204 with an associated hardwired data port (not illustrated). As this example illustrates, communications with cooperative traffic congestion detection controller 125 can include either or both wired and wireless communications circuits 201. In some embodiments, the communication circuit 201 may implement the IR wireless communications from the vehicle to a hydrogen fueling station. Wireless transceiver circuit 202 can include a transmitter and a receiver (not shown) to allow wireless communications via any of a number of communication protocols such as, for example, WiFi, Bluetooth, near field communications (NFC), Zigbee, IrDA, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by cooperative traffic congestion detection controller 125 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 512 can include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 2. Sensors 152 can include additional sensors that may or not otherwise be included on a standard vehicle with which the safety-aware AI system 200 is implemented. In the illustrated example, sensors 152 include vehicle acceleration sensors 212, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation.

Vehicle systems 158 can include any of a number of different vehicle components or subsystems used to control or monitor various aspects of the vehicle and its performance. In this example, the vehicle systems 158 include a GPS or other vehicle positioning system 272; torque splitters 274 they can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, and other vehicle systems.

During operation, cooperative traffic congestion detection controller 125 can receive information from various vehicle sensors 152. Also, the driver may manually activate the cruise control mode by operating switch 205. Communication circuit 201 can be used to transmit and receive information between the cooperative traffic congestion detection controller 125 and sensors 152, and cooperative traffic congestion detection controller 125 and vehicle systems 158. Also, sensors 152 may communicate with vehicle systems 158 directly or indirectly (e.g., via communication circuit 201 or otherwise).

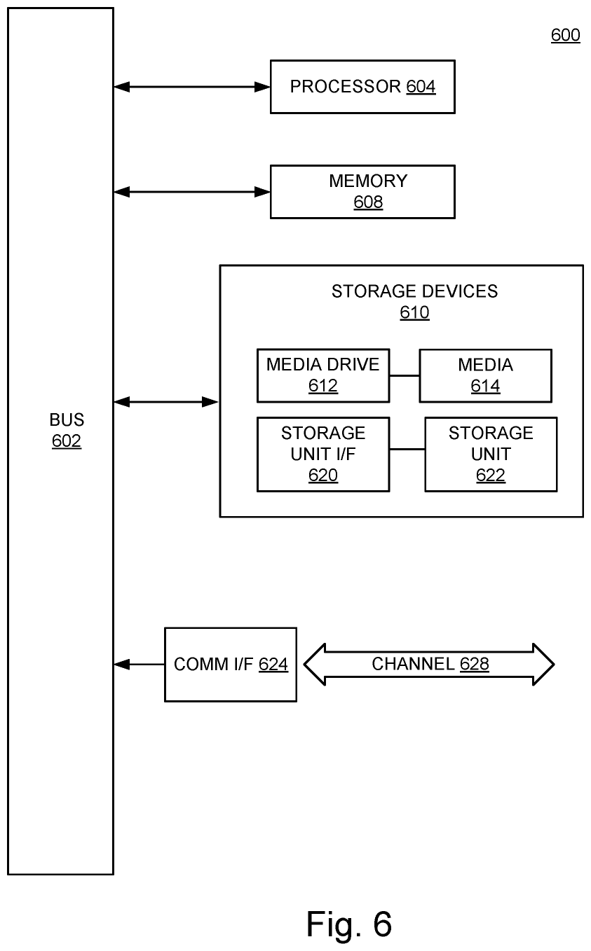

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example—computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 400 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. This can include a processor 604. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 400.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 424 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 620, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 400 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
one or more communication sensors receiving vehicle data and sensor data;
a learning-based module generating a predicted traffic congestion condition based on analyzing the received vehicle data and the sensor data; and
a controller device generating a notification based on the predicted traffic congestion condition such that additional time is provided for a driver to revise driving actions or driving routes.

2. The system of claim 1, wherein the system comprises a sensor rich vehicle.

3. The system of claim 2, wherein the received vehicle data and the sensor data is communicated by a plurality of vehicles communicatively connected to the sensor rich vehicle.

4. The system of claim 3, wherein the plurality of vehicles comprises additional sensor rich vehicles and legacy vehicles.

5. The system of claim 4, the system further comprising:
a consensus module analyzing one or more additional predicted traffic congestion conditions and generating a validated traffic congestion condition based on a convergence between one or more additional predicted traffic congestion conditions and the generated predicted traffic congestion condition.

6. The system of claim 5, wherein the one or more additional predicted traffic congestion conditions are generated and communicated by the plurality of vehicles communicatively connected to the sensor rich vehicle.

7. The system of claim 3, wherein the controller device generates the notification in response to the validated traffic congestion condition.

8. The system of claim 3, wherein the one or more communication sensors receive the vehicle data and the sensor data via an ad-hoc network between the plurality of vehicles communicatively connected to the sensor rich vehicle.

9. The system of claim 8, wherein the ad-hoc network comprises vehicle-to-vehicle (V2V) communication between the plurality of vehicles communicatively connected to the sensor rich vehicle.

10. The system of claim 9, wherein the vehicle data comprises sensor data that is generated by one or more vehicle sensors and comprises at least one of: motion data, direction data, road data, and lane data.

11. The system of claim 3, wherein the predicted traffic congestion condition is communicated to the plurality of vehicles communicatively connected to the sensor rich vehicle.

12. The system of claim 7, wherein the notification is communicated to the plurality of vehicles communicatively connected to the sensor rich vehicle as a warning of detected traffic congestion.

13. The system of claim 5, further comprising:
a computer-controlled mode, wherein the validated traffic congestion condition effectuates a computer-controlled automated driving maneuver or automated driving action of the vehicle.

14. A non-transitory computer readable medium comprising instructions, that when read by a processor, cause the processor to perform:
receiving vehicle data;
applying a learning-based model to the received vehicle data to generate a predicted traffic congestion condition; and
generating a notification based on the predicted traffic congestion condition such that additional time is provided for a driver to revise driving actions or driving routes.

15. The non-transitory computer readable medium of claim 14, wherein the received vehicle data and the sensor data is communicated by a plurality of vehicles via an ad-hoc network.

16. The non-transitory computer readable medium of claim 15, comprising instructions that further cause the processor to perform:
analyzing one or more additional predicted traffic congestion conditions and generating a validated traffic congestion condition based on a convergence between one or more additional predicted traffic congestion conditions and the generated predicted traffic congestion condition.

17. The non-transitory computer readable medium of claim 16, comprising instructions that further cause the processor to perform:
receive the one or more additional predicted traffic congestion conditions from the plurality of vehicles via the ad-hoc network, wherein the one or more additional predicted traffic congestion conditions are generated and communicated by the plurality of vehicles.

18. The non-transitory computer readable medium of claim 17, wherein the ad-hoc network comprises vehicle-to-vehicle (V2V) communication.
